(19) United States
(12) Patent Application Publication
(10) Pub. No.: US 2003/0019096 A1
(43) Pub. Date: Jan. 30, 2003

(54) Magnetic devices comprising magnetic meta-materials

(76) Inventor: Timothy P. Weihs, Baltimore, MD (US)

Correspondence Address: LOWENSTEIN SANDLER PC, 65 LIVINGSTON AVENUE, ROSELAND, NJ, 07068, US

(21) Appl. No.: 10/178,577

(22) Filed: Jun. 24, 2002

Related U.S. Application Data
(60) Provisional application No. 60/301,002, filed on Jun. 26, 2001.

(51) Int. Cl. H01F 7/06; H01F 3/04

(52) U.S. Cl. 29/609; 29/607; 428/900

(57) ABSTRACT

In accordance with the invention, a magnetic device is made by providing magnetic sheet layers with reactive joining materials that will react to join the layers into a unitary body. The joining materials are reacted, and the device is formed. In a preferred embodiment, the magnetic material is a soft magnetic material such as FeCo alloy, and the reactive joining materials are aluminum and FeCoOₓ which react to form nonconducting alumina layers between magnetic regions.

### CROSS REFERENCE TO RELATED APPLICATIONS

This application claims the benefit of U.S. Provisional Application Serial No. 60/301,002 filed by Timothy Weiss on Jun. 26, 2001 and entitled “Magnetic Devices Comprising Magnetic Meta-Materials”. The 301,002 application is incorporated herein by reference.

### FIELD OF THE INVENTION

This invention relates to magnetic devices and, in particular, to magnetic devices comprising unitary multilayer composites of reactively joined magnetic layers (magnetic meta-materials). In a preferred embodiment sheets of soft magnetic material, such as FeCo, are reactively joined to form magnetic bearings.

### BACKGROUND OF THE INVENTION

High performance magnetic materials are useful for a variety of applications such as electric motors, starters, generators, and magnetic bearings that can be used in automobiles, aircraft, land-based turbines, and marine-based turbines. In magnetic bearings, the rotors of are made of soft magnetic materials. In many applications high performance magnetic materials need superior magnetic and mechanical properties at elevated temperatures. In addition the materials may need to be structured to avoid large eddy current losses.

Conventional magnetic rotors are typically composed of many FeCo sheets that have been cut into particular cross-sectional geometries, oxidized to form nonconducting FeCoOₓ outer layers, and then stacked and pressed together to form a cylindrical sleeve which is attached to a rotating shaft.

While this method of production has been successful for some applications, it suffers from several limitations. First, the resulting rotor is not a rigid, solid body. As a consequence, at high rotational speeds, vibrations and resonances can degrade the rotational performance of the rotor. While a solid rotor cast and machined into the desired geometry would have superior vibrational performance, electrical conduction throughout the rotor would be high, and eddy current losses would be unacceptable.

In important applications such as magnetic bearings for jet engines, the magnetic materials must exhibit superior soft magnetic properties and high strength and creep resistance at high temperatures which may approach 600° C. Of all the known soft magnetic materials only the FeCo alloys have the requisite soft magnetic properties at 600° C. However substantial improvements are required in the high-temperature mechanical properties of these alloys. Accordingly there is a need for magnetic materials having improved mechanical properties.

### SUMMARY OF THE INVENTION

In accordance with the invention, a magnetic device is made by providing magnetic sheet layers with reactive joining materials that will react to join the layers into a unitary body. The joining materials are reacted, and the device is formed. In a preferred embodiment, the magnetic material is a soft magnetic material such as FeCo alloy, and the reactive joining materials are aluminum and FeCoOₓ which react to form nonconducting alumina layers between magnetic regions.

### BRIEF DESCRIPTION OF THE DRAWINGS

The advantages, nature and various additional features of the invention will appear more fully upon consideration of the illustrative embodiments now to be described in detail in connection with the accompanying drawings. In the drawings:

FIG. 1 is a block diagram of the steps involved in fabricating a magnetic device in accordance with the invention;

FIGS. 2A and 2B schematically illustrate a first example of forming a magnetic device;

FIGS. 3A and 3B illustrate a second example of forming a magnetic device; and

FIG. 4 illustrates the components of a radial magnetic bearing made by the method of FIG. 1.

It is to be understood that these drawings are for purposes of illustrating the concepts of the invention and are not to scale.

### DETAILED DESCRIPTION

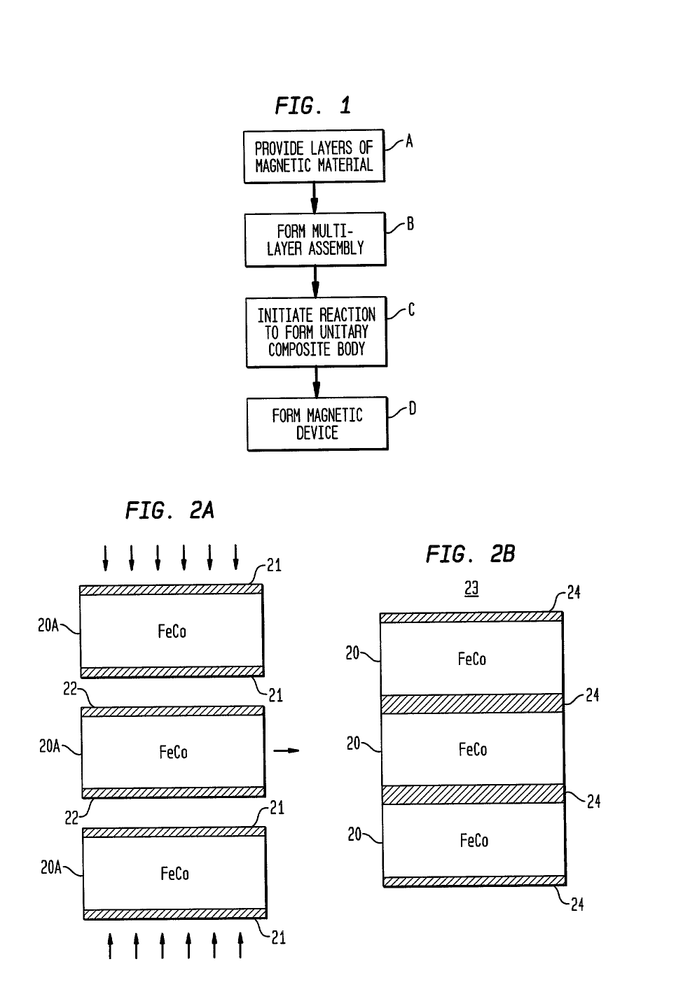

Referring to the drawings, FIG. 1 is a schematic diagram of the steps in fabricating a magnetic device in accordance with the invention. The first step, shown in Block A, is to provide a plurality of layers of magnetic material. Preferably the layers are sheets, foils or coatings of soft magnetic material, each layer having a thickness in the range 0.0001 to 1.0 in. Useful soft magnetic materials for this application include FeCo and its alloys, NiFe and its alloys, and amorphous ferromagnets.

The preferred soft magnetic material is FeCo alloy such as Hiperco FeCo alloys HA27, HA50 and HA50HS marketed by Carpenter Technology Inc., Wyomissing, Pa. 19610-1339. For high temperature use, the soft magnetic materials are advantageously dispersion hardened. This hardening can be effectuated, for example, by preparing a colloidal suspension of the soft magnetic material and dispersion particles such as oxide particles. A hardened two-phase soft magnet layer can then be electrochemically deposited from the suspension. For further details of this hardening process, see U.S. Provisional Patent Application No. 60/301,002 filed by T. P. Weihs on Jun. 26, 2001 and entitled “Magnetic Devices Comprising Magnetic Meta-Materials”. The application is incorporated herein by reference.

The next step shown in Block B is to form a multilayer assembly of magnetic layers and reactive joining materials. This can be accomplished by disposing between successive sheets of magnetic material, coatings or layers of reactive joining materials. The reactive joining materials will react to join the successive magnetic layers together. Advantageously, they will react to produce regions of nonconductive material between sheets of magnetic material. A variety of ways of forming an assembly of sheets and reactive joining materials are described in U.S. patent application Ser. No. 09/846,486 filed by T. P. Weihs et al. on May 1, 2001 and entitled “Freestanding Reactive Multilayer Foils”, which is incorporated herein by reference. An alternate approach is to provide such assemblies by mechanical deformation as described in U.S. patent application Ser. No. 09/846,447 filed by T. P. Weihs et al. on May 1, 2001 and entitled “Method of Making Reactive Multilayer Foil and Resulting Product.” Both applications are incorporated herein by reference.

Reactive joining materials as used herein refer to inorganic materials that upon ignition by a stimulus, usually heat and pressure, exothermically react to join layers of magnetic material together. The reactive joining materials are typically adjacent layers of distinct materials A and B amenable to mixing of neighboring atoms (or having changes in chemical bonding) in response to a stimulus. A and B can be elements or compounds. They can include adjacent layers of reducing material (e.g. aluminum) and oxide (e.g. FeCoOₓ), adjacent layers of transition metal (e.g. Ti) and a light element (e.g. Al), adjacent layers reactive to produce a silicide (e.g. Ni and Si), an aluminide (e.g. Ni and Al), a boride, or a carbide. A/B can also be a nitride with a low heat of formation adjacent a nitride with a large heat of formation or similarly chosen adjacent silicides, borides or carbides. Preferably the pairs A/B are chosen to form stable reaction compounds with negative heats of formation as described in Weihs, “Self-Propagating Reactions in Multilayer Materials”, Handbook of Thin Film Process Technology (1997), which is incorporated herein by reference.

The reactive joining materials can be disposed between layers of magnetic material in any one of a variety of ways. They can be formed on the magnetic material as by oxidation of FeCo layers to form a surface coating of oxide. They can be coated on the magnetic material as by sputtering or electrodeposition, or they can be self-supporting layers interleaved between successive magnetic sheets.

The reactive joining materials are advantageously chosen to not only join successive magnetic layers into a unitary body but also to provide useful structure to the body. For example, proper choice of the reactive joining materials can provide nonconducting layers of reaction product between successive magnetic layers to produce a unitary magnetic body with reduced eddy current losses. Alternatively, the materials can be chosen to provide a conductive reaction product for desired conductive pathways.

FIG. 2A illustrates one approach to providing reactive joining materials for FeCo sheets. Here half the FeCo sheets 20A are heated, as in air, to oxidize their outer surfaces. This heating creates, on each of their outer surfaces, an oxide film 21 of FeCoOₓ. The thickness of the oxide can be in the range 1 nm to about 100 micrometers and is preferably about 200 nm. The other half of the FeCo sheets (alternating sheets 20B) can be coated with layers 22 of aluminum or aluminum alloy having a thickness in the range 1 nm to 1000 μm and preferably about 200 nm. Al is a reactive reducing element producing an oxide that has a very high heat of formation. Advantageously a thin layer 23 of Ti (1-50 nm) can preliminary be deposited on the FeCo sheet to facilitate adhesion of the subsequently deposited aluminum coating. Alternatively, aluminum foil or leaf layers can be interposed between successive FeCo sheets. Other reactive, reducing elements which can be substituted for Al include Ti, Zr, and Hf.

The third step, shown in Block C, is to initiate a reaction between the reactive joining materials to laminate the assembly together into a unitary body of magnetic layers alternating with layers of reaction products. The successive sheets are stacked in an alternating fashion and uniaxially pressed together at a pressure in the range 0.01 to 100 MPa, and preferably 50 MPa. In the exemplary case of FeCo sheets at a pressure of 50 MPa, the stack of sheets can be heated rapidly to 700° C. to initiate the following reaction between the coatings and layers:

2Al+FeCoOₓ→Al₂O₃+FeCo+Heat

The atomic mixing that occurs during this reaction achieves strong chemical bonds at the FeCo/Al₂O₃ interfaces thereby producing a unitary composite body. Alternatively, sheets, layers or coatings of Zr, Ti or Hf can be disposed to reduce oxides on magnetic sheets to produce ZrO₂, TiO₂ or HfO₂, respectively.

FIG. 2B illustrates the resulting unitary composite 23 which typically comprises a series of soft magnetic layers 20 separated by reaction product layers 24. Here FeCo layers 20 (0.0001 in to 1.0 in) are separated by Al₂O₃ (alumina) layers 24 (1 nm to 1000 micrometers). The nonconductive alumina layers 24 not only inhibit eddy currents within the body but also improve the creep resistance of the body.

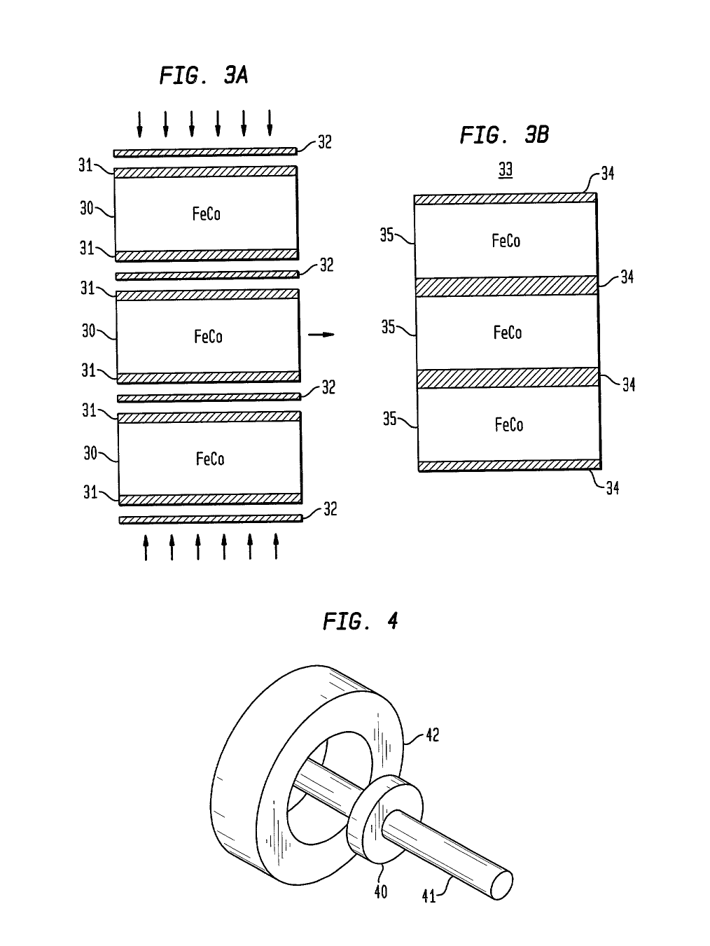

FIGS. 3A and 3B illustrate an alternative arrangement of reactive coatings and layers. In FIG. 3A each sheet 30 of FeCo is oxidized on both major surfaces to produce oxide films 31 on the top and bottom. Thin sheets 32 of aluminum (preferably about 1 micrometer thick) are disposed between the oxide coated FeCo sheets. The assembly is then compressed and heated to produce the unitary structure 33 of FIG. 3B with alumina regions 34 between successive regions of FeCo 35.

The next step (Block D) is to form the magnetic device of reactively joined magnetic material. This can be done by shaping the sheets of the multilayer assembly prior to initiating the reaction in step C of FIG. 1 or by shaping (as by machining) the unitary composite after the reaction. A variety of magnetic devices can be so formed, including rotors or cores for starters, generators, or magnetic bearings. The preferred application is rotors for magnetic bearings.

FIG. 4 schematically illustrates the components of a typical radial magnetic bearing comprising a rotor 40 attached to a shaft 41 and a rotor housing (stator) 42. The rotor 40 is made as described in step D of FIG. 1. It can be formed by stacking, pressing and reacting precut circular sheets having cut out centers.

The advantages of magnetic devices made by the process of FIG. 1 are manyfold. First, the inorganic chemical bonding between the FeCo and Al₂O₃ is very strong—as strong or stronger than the best adhesives. More importantly, this inorganic bond can handle the broadest possible range of temperatures—from 100° C. to 1000° C., whereas most organic adhesives would fail above 200° C. This is important for high temperature applications.

Second, an inorganic Al₂O₃ layer is chemically very inert so that attacks by acids or bases in corrosive environments will have limited impact, far less than for the case of an organic adhesive.

Third, an inorganic bond layer of Al₂O₃, ZrO₂, TiO₂, or HfO₂ is a ceramic. It has a very high dielectric breakdown voltage and a very high resistance to electrical conduction (>10¹² ohm-m). Thus, it provides excellent electrical isolation of neighboring sheets of FeCo. Al₂O₃ also has very high stiffness (300 GPa), strength (330 MPa), and creep resistance, all of which are higher than the mechanical properties of the FeCo sheets. Thus the bond layer helps form a very strong laminated composite.

Fourth, Al₂O₃ has very low density (3.9 g/cc) which is a benefit in rotary applications where centrifugal loads scale with density.

Lastly, this bonding process enables one to vary the thickness of the Al₂O₃ layer by varying the thickness of the original Al layer prior to diffusion bonding.

The same advantages also hold as well for other inorganic oxide layers (e.g. ZrO₂, TiO₂, and HfO₂). The advantages of stiffness, strength, creep resistance, and low density hold for the borides, suicides, and carbides.

This type of reactive joining of magnetic layers can also be effected using other reactive joining materials. For example, a nitride with a low heat of formation can be exchanged for a nitride with a high heat of formation to join magnetic layers between them. In applications needing intervening conducting layers rather than nonconducting layers, silicides, borides or carbides with low heats of formation can be exchanged for their respective counterparts with high heats of formation.

It is to be understood that the above-described embodiments are illustrative of only a few of the many possible specific embodiments which can represent applications of the principles of the invention. Numerous and varied other arrangements can be readily devised by those skilled in the art without departing from the spirit and scope of the invention.

What is claimed is:

1. A method of making a magnetic device comprising the steps of:
providing a plurality of layers of magnetic material;
disposing layers of reactive joining materials between the layers of magnetic material to form a multilayer assembly;
reacting the reactive joining materials to join together the layers of the assembly into a unitary multilayer composite; and
forming the magnetic device of the unitary composite.

2. The method of claim 1 wherein the layers of magnetic material comprise layers of soft magnetic material.

3. The method of claim 1 wherein the reactive joining materials comprise layers of exothermically reacting inorganic material.

4. The method of claim 1 wherein the reactive joining materials comprise layers of oxide and reducing material.

5. The method of claim 1 wherein the reactive joining materials comprise layers of oxide and metal for reducing the oxide.

6. The method of claim 1 wherein the layers of magnetic material comprise layers of FeCo or FeCo alloy.

7. The method of claim 1 wherein the layers of magnetic material comprise layers of NiFe or NiFe alloys.

8. The method of claim 1 wherein the layers of magnetic material comprise layers of amorphous ferromagnetic material.

9. The method of claim 1 wherein the layers of magnetic material comprise a plurality of layers of magnetic material each having a thickness within the range 0.0001 to 1 in.

10. The method. of claim 1 wherein the layers of reactive joining materials comprise coatings of oxide of the magnetic material.

11. The method of claim 1 wherein the layers of reactive joining materials are provided by oxidizing surfaces of the magnetic layers and providing sheets or coatings of reducing material adjacent the oxidized surfaces.

12. The method of claim 11 wherein the reducing material is Al, Ti, Zr or Hf.

13. The method of claim 11 wherein the layers of magnetic material comprise layers of FeCo or FeCo alloy and the layers of reactive joining materials comprise layers of aluminum adjacent layers of oxide.

14. The method of claim 13 wherein the layers of oxide comprise coatings of oxide of the FeCo or FeCo alloy.

15. The method of claim 1 wherein the layers of reactive joining materials comprise adjacent layers of nitrides having different heats of formation.

16. The method of claim 1 wherein the layers of reactive joining materials comprise adjacent layers of silicides having different heats of formation.

17. The method of claim 1 wherein the layers of reactive joining materials comprise adjacent layers of borides having different heats of formation.

18. The method of claim 1 wherein the layers of reactive joining materials comprise adjacent layers of carbides having different heats of formation.

19. The method of claim 1 wherein the unitary multilayer composite comprises alternating layers of magnetic material and nonconducting material.

20. The method of claim 1 wherein the unitary multilayer composite comprises alternating layers of magnetic material and conducting material.

21. The method of claim 1 wherein the unitary multilayer composite comprises alternating layers of FeCo or FeCo alloy and alumina.

22. The method of claim 1 wherein the magnetic layers are sheets and forming the multilayer composite into the magnetic device comprises shaping the sheets of the multilayer assembly prior to reacting the joining material.

23. The method of claim 1 wherein forming the multilayer composite into the magnetic device comprises shaping the unitary multilayer composite.

24. The method of claim 1 wherein the layers of magnetic material comprise layers of dispersion hardened soft magnetic material.

25. A magnetic device made by the process of claim 1.

26. A magnetic device made by the process of claim 2.

27. A magnetic device made by the process of claim 3

28. A magnetic device made by the process of claim 4.

29. A magnetic device comprising a unitary multilayer composite comprising:
a plurality of layers of magnetic material;
and a plurality of layers of inorganic material comprising the reaction product of inorganic joining materials, the layers of inorganic material alternating with the layers of magnetic material.

30. The device of claim 29 wherein the magnetic material comprises soft magnetic material.

31. The device of claim 29 wherein the layers of inorganic material are nonconductive.

32. The device of claim 29 wherein the magnetic material comprises FeCo or an FeCo alloy.

33. The device of claim 32 wherein the layers of inorganic material comprise layers of alumina.
